(19) United States
(12) Patent Application Publication
(10) Pub. No.: US 2011/0173577 A1
(43) Pub. Date: Jul. 14, 2011

(54) Techniques for Pattern Process Tuning and Design Optimization for Maximizing Process-Sensitive Circuit Yields

(75) Inventors: Ching-Te K. Chuang, South Salem, NY (US); Fook-Luen Heng, Yorktown Heights, NY (US); Rouwaida Kanj, Round Rock, TX (US); Keunwoo Kim, Somers, NY (US); Jin-Fuw Lee, Yorktown Heights, NY (US); Saibal Mukhopadhyay, Atlanta, GA (US); Sani Richard Nassif, Austin, TX (US); Rama Nand Singh, Bethel, CT (US)

(73) Assignee: International Business Machines Corporation, Armonk, NY (US)

(21) Appl. No.: 12/024,390

(22) Filed: Feb. 1, 2008

(51) Int. Cl. G06F 17/50

(52) U.S. Cl. 716/53; 716/54

(57) ABSTRACT

Techniques for improving circuit design and production are provided. In one aspect, a method for virtual fabrication of a process-sensitive circuit is provided. The method comprises the following steps. Based on a physical layout diagram of the circuit, a virtual representation of the fabricated circuit is obtained that accounts for one or more variations that can occur during a circuit production process. A quality-based metric is used to project a production yield for the virtual representation of the fabricated circuit. The physical layout diagram and/or the production process are modified. The obtaining, using and modifying steps are repeated until a desired projected production yield is attained.

### STATEMENT OF GOVERNMENT RIGHTS

This invention was made with Government support under Contract Number: HR0011-07-9-0002 awarded by (DARPA) Defense Advanced Research Projects Agency. The Government has certain rights in this invention.

### FIELD OF THE INVENTION

The present invention relates to circuit design and production, and more particularly, to virtual fabrication techniques for maximizing process-sensitive circuit production yields.

### BACKGROUND OF THE INVENTION

Advances in semiconductor technology are needed to accommodate the scaling demands of today's high-density circuits and small, yet power-efficient, high-performance devices. Static random access memory (SRAM) is a key technology driver in terms of scaling. SRAM, however, exhibits severe process sensitivities. For example, SRAM is highly sensitive to dopant variations that can occur during production and which can lead to soft errors in the completed device. As feature sizes are reduced, the effects of production variations are exacerbated. As a result, production quality can decrease exponentially with feature size.

Conventionally, multiple process development and design cycles are used to ramp up SRAM production. Each of these development/design cycles is very costly. With scaled SRAM applications, the costs involved are even greater thus making this process, in many instances, prohibitively expensive. Therefore, being able to fine-tune the production process and/or design ahead of the ramp up stage would be desirable. Current computer-aided design (CAD) and virtual fabrication tools, however, are not equipped to handle all of the parameters of a scaled SRAM fabrication. For a description of virtual fabrication, see, for example, U.S. Pat. No. 6,928,334 issued to Kuo, entitled “Mechanism for Inter-fab Mask Process Management.”

Thus, there exists a need for techniques to facilitate process tuning and/or design optimization ahead of the ramp up stage for SRAM production.

### SUMMARY OF THE INVENTION

The present invention provides techniques for improving circuit design and production. In one aspect of the invention, a method for virtual fabrication of a process-sensitive circuit is provided. The method comprises the following steps. Based on a physical layout diagram of the circuit, a virtual representation of the fabricated circuit is obtained that accounts for one or more variations that can occur during a circuit production process. A quality-based metric is used to project a production yield for the virtual representation of the fabricated circuit. The physical layout diagram and/or the production process are modified. The obtaining, using and modifying steps are repeated until a desired projected production yield is attained.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for virtual fabrication of a process-sensitive circuit according to an embodiment of the present invention;

FIGS. 2-6 are diagrams illustrating an exemplary methodology for acquiring circuit production process variation distributions according to an embodiment of the present invention;

FIG. 7 is a diagram illustrating an exemplary methodology for obtaining virtual representation of a circuit according to an embodiment of the present invention;

FIG. 8 is a diagram illustrating an exemplary methodology for performing a lithography simulation according to an embodiment of the present invention;

FIG. 9 is a diagram illustrating an exemplary system for virtual fabrication of a process-sensitive circuit according to an embodiment of the present invention;

FIGS. 10A-B are diagrams illustrating exemplary circuit data that can be input into one or more of the methodologies described herein according to an embodiment of the present invention;

FIGS. 11A-B are graphs illustrating disturb fail probability as a function of patterning process parameters for a memory cell according to an embodiment of the present invention; and

FIG. 12 is a graph illustrating disturb fail limited yield according to an embodiment of the present invention.

### DETAILED DESCRIPTION OF PREFERRED EMBODIMENTS

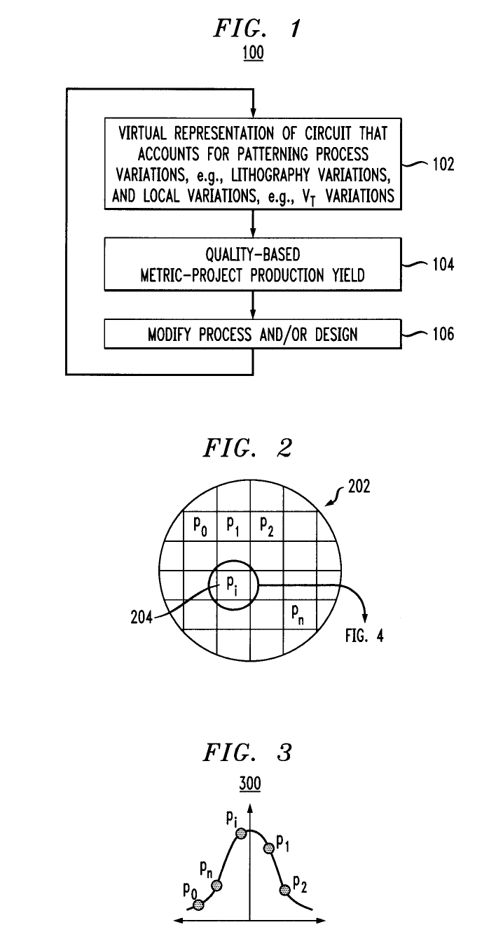

FIG. 1 is a diagram illustrating exemplary methodology 100 for virtual fabrication of a process-sensitive circuit. Methodology 100 provides an overview of the techniques described herein. The term “process-sensitive circuit,” as used herein, generally includes any circuit whose function and/or quality can be affected by a particular production process. Exemplary process-sensitive circuits include, but are not limited to, memory cells, such as static random access memory (SRAM) and dynamic random access memory (DRAM) cells. As will be described in detail below, the performance of memory cells, such as SRAM cells, can be affected by variations that occur during a circuit production process, such as random dopant fluctuations (RDFs) which can result in threshold voltage (V_{T}) variations and/or patterning process variations, such as lithography variations.

A very large scale integration (VLSI) process typically begins with a circuit schematic, e.g., having SRAM and/or DRAM cells, being adapted into a physical layout diagram by designers (i.e., a graphical depiction of the circuit, typically comprising a plurality (or pattern) of shapes, such as polygons and rectangles, and/or various layers of the circuit). Based on the physical layout diagram, a series of patterning process steps, such as lithography, etching, deposition, ion implantation and/or diffusion, are conducted to produce the circuit. The fabrication is generally performed on silicon (Si) wafers which can be as large as twelve inches in diameter. On each wafer there are many dies which are exposed, one at a time, during a single wafer scan. Each die will form a chip that will comprise, in addition to other circuitry, a plurality of memory cells that are expected to perform together as memory arrays.

The circuit production process is defined by a number of parameters. Patterning parameters include exposure dose and focus and overlay error in the alignment of one physical layer to the next during lithography. Cell-to-cell variations in diffusion cause random variations in the number and locations of dopant atoms resulting in random V_{T} variations in the memory cells. The global variation in the process parameters corresponding to each die, and intrinsic random variations in the process parameters corresponding to each memory cell of an array have emerged as a major design challenge of circuit design in the nanometer regime. The control of the variations in the patterning process parameters by process tuning can significantly improve the yield for a given physical layout of a circuit and also modifications in the physical layout of a circuit can improve the yield for a given process.

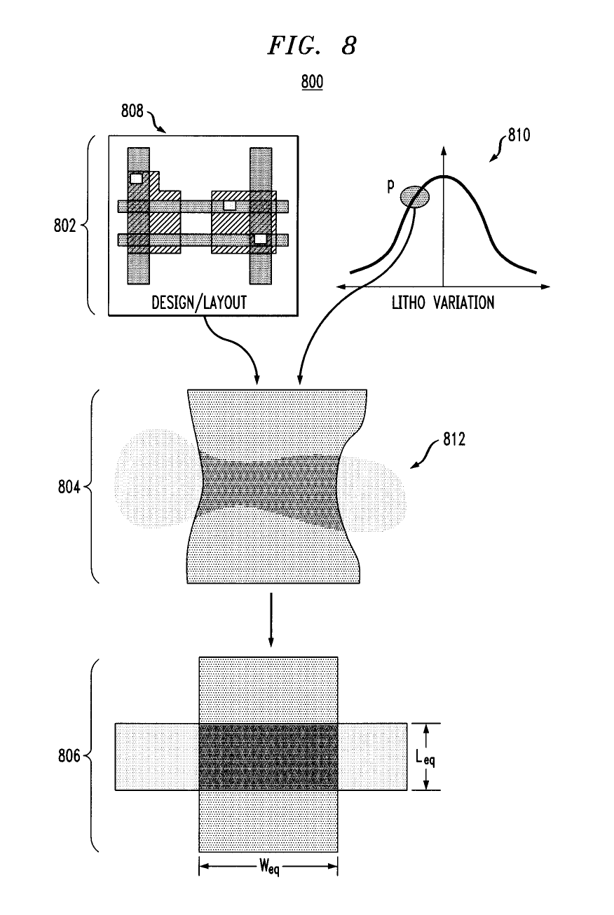

In step 102, based on a physical layout diagram of the circuit, a virtual representation of the fabricated circuit is obtained. For example, as will be described in conjunction with the description of FIG. 8, below, the virtual representation of the circuit can take the form of a lithography simulation. The virtual representation of the circuit accounts for variations that can occur during the circuit production process. For example, various patterning process variations, such as lithography variations, and local variations, such as RDFs that can result in V_{T} variations, are factored into the virtual representation of the circuit. By way of example only, the lithography simulation can be configured to take into account lithography variations (see below).

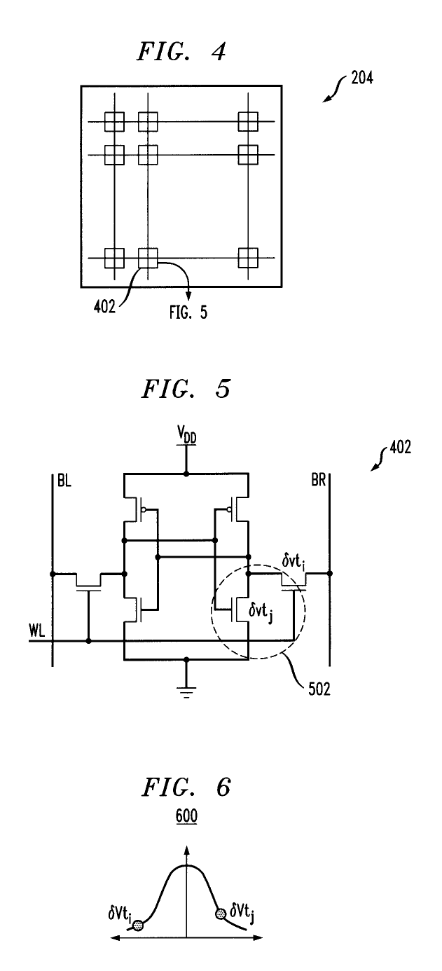

As will be described in detail in conjunction with the description of FIGS. 2-6, below, patterning process variations, such as lithography variations and/or etching variations, can be ascertained at the wafer-level based on a given wafer layout. Local variations, such as V_{T} variations resulting from RDFs, can be ascertained at the memory cell-level based on a given memory cell layout.

In step 104, a quality-based metric is used to project a production yield for the virtual representation of the circuit obtained in step 102, described above. For example, as will be described below, the quality-based yield metric can comprise a failure probability analysis, also referred to herein generally as a “disturb fail metric.” Failure probability analysis is described, for example, in S. Mukhopadhyay et al., “Modeling of Failure Probability and Statistical Design of SRAM Array for Yield Enhancement in Nanoscaled CMOS,” IEEE Transactions on Computer-Aided Design of Integrate Circuits and Systems, vol. 24, no. 12, pps. 1859-1880 (December 2005) (hereinafter “Mukhopadhyay”), the contents of which are incorporated by reference herein.

In step 106, if the projected production yield for the virtual representation of the circuit is not satisfactory then modifications to the production process and/or the circuit design can be made with an eye towards improving the projected production yield. Modifications to the circuit design can be made by making corresponding modifications to the physical layout diagram. Steps 102, 104 and 106 can then be repeated until a desirable quality-based yield is attained. Thereby, the production process and/or circuit design can be optimized through this virtual fabrication process.

FIGS. 2-6 are diagrams illustrating an exemplary methodology for acquiring circuit production process variation distributions. As described above, patterning process variations can include lithography and/or etching variations, and local variations can include V_{T} variations, i.e., resulting from RDFs.

FIG. 2 is a diagram illustrating patterning process parameters for a given wafer 202. Namely, as shown in FIG. 2, wafer 202 contains a set of values of various patterning process parameters, referred to hereinafter as “process points,” i.e., process points Pₒ, Pₙ, Pᵢ, P₁, P₂, etc. wherein each die corresponds to a given process point. For example, die 204 corresponds to process point Pᵢ. Die 204 is shown enlarged in FIG. 4 (described below). The number of process points examined can be chosen using conventional statistical design of experiments theory. Statistical design of experiments theory is described in the context of lithography variations in L. Liebmann et al., “Reducing DfM to Practice: the Lithography Manufacturability Assessor,” Proc. of SPIE, vol. 6156, pps. 178-189 (2006), the contents of which are incorporated by reference herein.

FIG. 3 is a graph 300 illustrating a mean and a standard deviation for the process points of wafer 202 (see FIG. 2, described above). By way of example only, if each process point Pₓ represents a lithography parameter, i.e., exposure focus, dose, mask-error and/or overlay, in a given die, then graph 300 would be illustrative of a mean and standard deviation for lithography variations (i.e., of that lithography parameter) across wafer 202. In this graph, the parameter whose variation is being considered is plotted on the x-axis, whereas the frequency of occurrence of a specific value for a process is being plotted on the y-axis, resulting in a plot which is referred to as a probability density function for that parameter. A probability density function can be specified as a mean and a standard deviation of the parameter. Lithography variations as well as other patterning process parameters can be determined, for example, using lithography simulations. Lithography simulations are described in detail, for example, in conjunction with the description of FIG. 8, below.

FIG. 4 is a diagram illustrating an enlarged view of die 204 (see FIG. 2, described above). As shown in FIG. 4, die 204 comprises a plurality of memory cells, e.g., SRAM or DRAM memory cells. One such memory cell, memory cell 402 is shown enlarged in FIG. 5 (described below).

FIG. 5 is a diagram illustrating an enlarged view of memory cell 402 (see FIG. 4, described above). As shown in FIG. 5, memory cell 402 comprises a plurality of transistors, such as transistor 502. Each memory cell in the die is subject to many local variations, such as RDFs, which are lumped together in the V_{T} variation for a technology, i.e., δV_{Ti}, δV_{Tj}, etc. For example, transistor 502 has V_{T} variation value δV_{Tj}. Each transistor in the cell is characterized by a V_{T} variation specified by a mean and a standard deviation established during the circuit development process and is dependent on effective length and width dimensions of the transistor. The dimensions of a transistor will be described below.

FIG. 6 is a graph 600 illustrating a mean and a standard deviation for the local variations of memory cell 402 (see FIG. 4, described above). Specifically, since each point δV_{Tx} represents a V_{T} variation value in a given transistor, then graph 600 is illustrative of a mean and standard deviation for local variations throughout memory cell 402. Local variation values can be determined from design manuals and/or from routine experimentation.

As described in conjunction with the description of FIG. 1, above, the patterning process parameters, e.g., lithography variations, and local variation data, e.g., V_{T} variations, will be used to determine the projected production yield for a given design and/or production process. Projected production yield is described below.

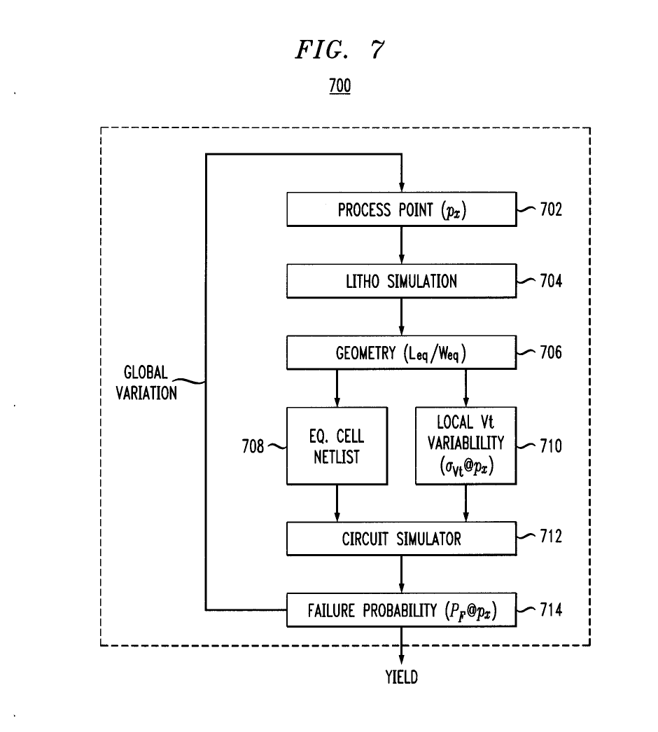

FIG. 7 is a diagram illustrating exemplary methodology 700 for obtaining virtual representation of a circuit. In step 702, a process point Pₓ is selected. As highlighted, for example, in conjunction with the description of FIG. 2, above, each die corresponds to a particular process point Pₓ.

In step 704, lithography simulations are performed. Lithography simulations are described in detail, for example, in conjunction with the description of FIG. 8, below. In general, lithography patterning produces a structure as close to the physical layout diagram as is possible. However, the physical layout diagram will comprise a plurality of polygons (as described above) and in practice there are almost always departures from a true rectangular (polygonal) shape. This discrepancy can be due in part to the lithography variations that can occur during the circuit production process, as described above. The lithography simulations take into account such variations and provide simulations of the shapes that would actually be printed. For example, the lithography simulations are performed based on models developed for the lithography technology used, such as for a particular printing tool and/or photoresist.

Thus, in step 706, the lithography simulations produce a representation of the circuit having a geometry that is slightly different from the physical layout diagram. This geometry is referred to hereinafter as “equivalent geometry.” For example, the polygons representing gate regions and/or source/drain regions of a transistor may have altered length and width dimensions, referred to hereinafter as “equivalent length” (L_{eq}) and “equivalent width” (W_{eq}), respectively. A method of calculating equivalent geometry is described in F. Heng et al., “Toward Through-Process Layout Quality Metrics,” Proceedings of the SPIE, vol. 5756, pps. 161-167 (2005), the contents of which are incorporated by reference herein.

In step 708, in order to determine the electrical function ability of VLSI circuits, the physical layout diagram undergoes a process known as resistance capacitance (RC) extraction wherein the polygon patterns and various layers in the physical layout diagram are translated into an electrically equivalent network described in the form of a netlist, which is a suitable input for commercial circuit simulators, such as HSPICE available from Synopsys, Inc., Mountain View, Calif. According to one exemplary embodiment, the netlist is modified with the polygons resulting from the lithography simulations (e.g., that take into account lithography variations) by substituting the equivalent geometry in place of the drawn geometry (from the physical layout diagram) in the netlist. This type of RC extraction is referred to hereafter as a “process-aware extraction,” because production process variations, e.g., lithography variations, are taken into account. According to another exemplary embodiment of the process-aware extraction, a more accurate through-process model of the circuit or of contacts used for connectivity to the circuit in terms of either a set of I-V characteristics and/or resistance models may be inserted within the purview of the process-aware extraction. The process-aware extraction implies deriving the netlist that contains the variations in the circuits and contacts resulting from process changes which are in turn described by through-process models.

In step 710, local variations are determined. As described above, a mean and standard deviation can be determined for local variations throughout a given memory cell. See, for example, FIG. 6, described above.

In step 712, the netlist generated by the process-aware extraction is then fed into, i.e., processed by, a circuit simulator which takes into account the local variations, e.g., RDFs, that can lead to V_{T} variations in one or more of the memory cells of the die. See, for example, FIGS. 5 and 6 (described above). According to an exemplary embodiment, the information fed into the circuit simulator is obtained as follows. Design manuals are used to specify the V_{T} variations for a certain generic specified circuit. However, as described above, the lithography process changes the geometry which gets described as an equivalent geometry (based on the lithography simulation) for each process point. The design manual specification is then scaled to give the V_{T} variation for the (lithography) simulated geometry. By way of example only, the circuit simulator can compute the various types of functional failure probabilities of one or more of the memory cells using SPICE and a fast Monte-Carlo Analysis.

In step 714, based on the combined failure probabilities of the memory cells, a failure probability P_{F} of the die (process point Pₓ) is computed. The failure probability P_{F} of the die can then be used to project the quality metric based yield. See, for example, Mukhopadhyay. The methodology, as outlined in steps 702-714 can be repeated for various other process points to determine global variations across the wafer.

As highlighted above, if the yield is not satisfactory, then improvements to the production process and/or circuit design can be made. By way of example only, small changes in the physical layout such as moving the shapes on the poly and diffusion layers (i.e., corresponding to polysilicon (poly-Si) gate regions and source/drain diffusion regions, respectively (see below)) can then be made to check if the modifications improve the yield (i.e., by making the modification and performing methodology 700 again). In a similar manner, for a given physical layout, small changes of the statistical prescription, such as the mean and standard deviations of the patterning process parameters can be made until they are satisfactory for a physical layout and technology.

FIG. 8 is a diagram illustrating exemplary methodology 800 for performing a lithography simulation. In step 802, a physical layout diagram 808 is provided. In most production schemes, the physical layout diagram undergoes a process called optical proximity correction (OPC) which modifies each shape, i.e., polygon, in the physical layout diagram to insure that the lithography patterning produces a structure as close to the physical layout diagram as is possible. The shapes coming out of the OPC process are used (as models) to produce a mask that is then used to expose a wafer by lithography machines such as steppers. But, as highlighted above, there are almost always departures from a true rectangular shape due, e.g., to lithography variations.

According to the present teachings, patterning process parameters, such as lithography variations 810, are factored into the lithography simulation. For example, in one exemplary embodiment, a commercially available tool such as Calibre, available from Mentor Graphics, Wilsonville, Oreg., is used together with the models describing the printing of the mask shapes onto the wafer to obtain simulations of the shapes that would actually be printed.

In step 804, the lithography simulations (which take into account lithography variations 810) produce virtual representation 812 of physical layout diagram 808. As highlighted above, virtual representation 812 will have a geometry that is slightly different from the physical layout diagram 808. In step 806, the equivalent geometry of virtual representation 812 can be presented as polygons each having L_{eq} and W_{eq} dimensions. As highlighted above, these polygons may represent gate regions and/or source/drain regions of a transistor in the physical layout.

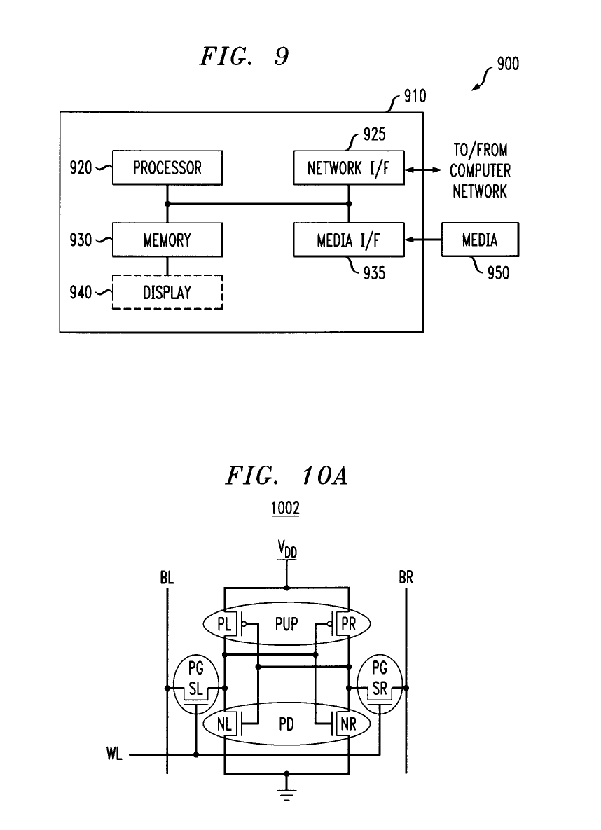

Turning now to FIG. 9, a block diagram is shown of an apparatus 900 for virtual fabrication of a process-sensitive circuit, in accordance with one embodiment of the present invention. It should be understood that apparatus 900 represents one embodiment for implementing methodology 100 of FIG. 1.

Apparatus 900 comprises a computer system 910 and removable media 950. Computer system 910 comprises a processor 920, a network interface 925, a memory 930, a media interface 935 and an optional display 940. Network interface 925 allows computer system 910 to connect to a network, while media interface 935 allows computer system 910 to interact with media, such as a hard drive or removable media 950.

As is known in the art, the methods and apparatus discussed herein may be distributed as an article of manufacture that itself comprises a machine-readable medium containing one or more programs which when executed implement embodiments of the present invention. For instance, the machine-readable medium may contain a program configured to, based on a physical layout diagram of the circuit, obtain a virtual representation of the fabricated circuit that accounts for one or more variations that can occur during a circuit production process; use a quality-based metric to project a production yield for the virtual representation of the fabricated circuit; modify one or more of the physical layout diagram and the production process; and repeat the obtaining, using and modifying steps until a desired projected production yield is attained.

The machine-readable medium may be a recordable medium (e.g., floppy disks, hard drive, optical disks such as removable media 950, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor 920 can be configured to implement the methods, steps, and functions disclosed herein. The memory 930 could be distributed or local and the processor 920 could be distributed or singular. The memory 930 could be implemented as an electrical, magnetic or optical memory, or any combination of these or other types of storage devices. Moreover, the term “memory” should be construed broadly enough to encompass any information able to be read from, or written to, an address in the addressable space accessed by processor 920. With this definition, information on a network, accessible through network interface 925, is still within memory 930 because the processor 920 can retrieve the information from the network. It should be noted that each distributed processor that makes up processor 920 generally contains its own addressable memory space. It should also be noted that some or all of computer system 910 can be incorporated into an application-specific or general-use integrated circuit.

Optional video display 940 is any type of video display suitable for interacting with a human user of apparatus 900. Generally, video display 940 is a computer monitor or other similar video display.

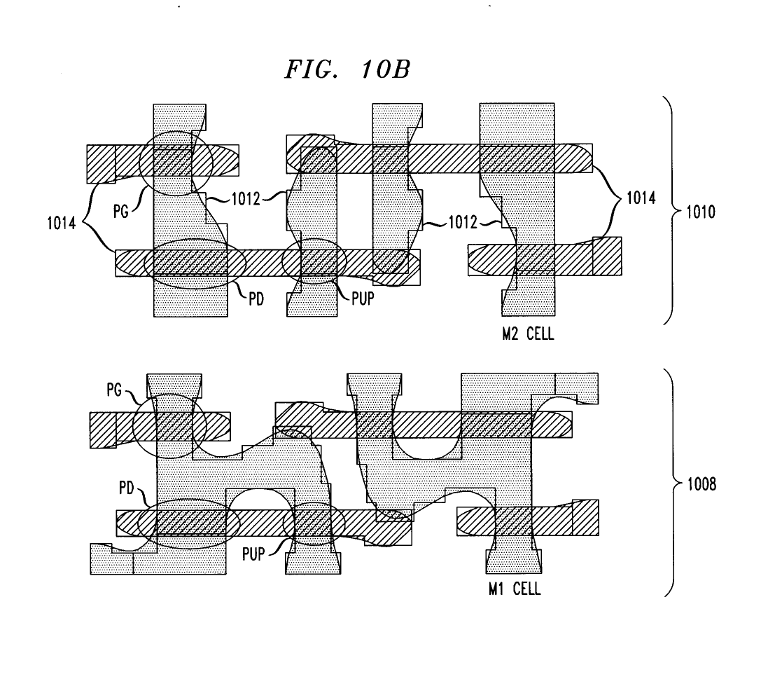

FIGS. 10A-B are diagrams illustrating exemplary circuit data that can be input into one or more of the methodologies described herein. Specifically FIG. 10A is a diagram illustrating exemplary circuit schematic 1002 containing two memory cells (i.e., memory cells M1 and M2, see FIG. 10B, described below). In circuit schematic 1002, the transistors are labeled “PUP” (pull-up transistor), “PG” (pass-gate transistor) and “PD” (pull-down transistor). Further, “WL” is used to identify a wordline, “BL” and “BR” are used to identify a left bitline and a right bitline, respectively, “PL” and “PR” are used to identify a left p-channel metal-oxide semiconductor (PMOS) and a right PMOS, respectively, “NL” and “NR” are used to identify a left n-channel metal-oxide semiconductor (NMOS) and a right NMOS, respectively, “SL” and “SR” are used to identify a left pass-gate and a right pass-gate, respectively.

FIG. 10B is a diagram illustrating a physical layout diagram, based on circuit schematic 1002 (of FIG. 10A), comprising SRAM memory cell 1008 (labeled “M1 cell”) and SRAM memory cell 1010 (labeled “M2 cell”). Each memory cell comprises multiple poly-Si gate regions and multiple source/drain diffusion regions, i.e., source/drain diffusion regions 1012 and poly-Si gate regions 1014. Overlaying the physical layout diagram, which is depicted by the rectilinear lines, are lithography simulations of the poly-Si gate and source/drain diffusion regions, which are depicted by the shaded curvilinear shapes. Lithography simulations were described above.

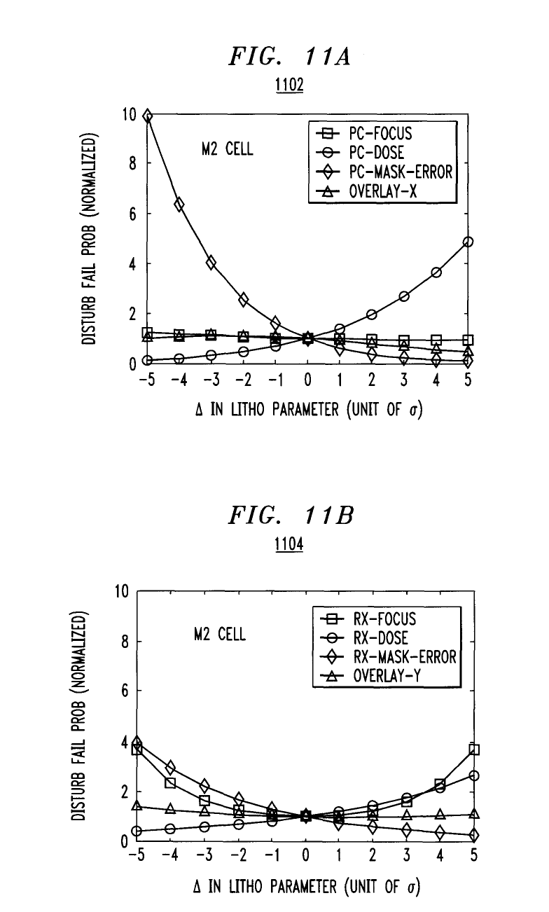

FIGS. 11A-B are graphs illustrating disturb fail probability as a function of patterning process parameters for SRAM memory cell M2 of FIGS. 10A-B (described above). Specifically, FIG. 11A is a graph 1102 illustrating disturb fail probability as a function of patterning process parameters, i.e., lithography variation (labeled “Δ in litho parameter (unit of σ)”) for the poly-Si gate regions (labeled “PC”) of SRAM memory cell M2. FIG. 11B is a graph 1104 illustrating disturb fail probability as a function of patterning process parameters, i.e., lithography variation (labeled “Δ in litho parameter (unit of σ)”) for the source/drain diffusion regions (labeled “RX”) of SRAM memory cell M2. The parameters plotted are exposure focus, dose, mask-error and overlay. Graphs 1102 and 1104 present exemplary data that can be output from one or more of the methodologies described herein.

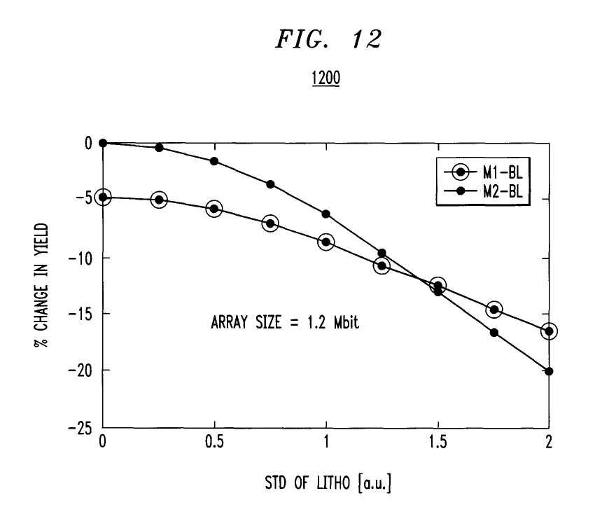

FIG. 12 is a graph 1200 illustrating disturb fail limited yield. Disturb fail limited yield is based on a disturb fail quality-based metric, and derived from the disturb fail probabilities, such as the ones plotted in graphs 1102 and 1104 (see FIGS. 11A-B, described above). The disturb fail limited yield is plotted as a function of the process parameter described in units of the standard deviation (std) (described in absolute units (a.u), such as micrometers (μm) of exposure focus) of the parameter (e.g., lithography (litho)) on the x-axis versus percent (%) change in yield on the y-axis, and compared for both SRAM memory cells M1 and M2 (see FIGS. 10A-B, described above) to enable a comparison of the yields of one cell, normalized with respect to the other cell, as a function of the patterning process parameters (which is limited to the lithography parameters for this example). The array size is 1.2 megabits (Mbit).

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for virtual fabrication of a process-sensitive circuit, the method comprising the steps of:
based on a physical layout diagram of the circuit, obtaining a virtual representation of the fabricated circuit that accounts for one or more variations that can occur during a circuit production process;
using a quality-based metric to project a production yield for the virtual representation of the fabricated circuit;
modifying one or more of the physical layout diagram and the production process; and
repeating the obtaining, using and modifying steps until a desired projected production yield is attained.

2. The method of claim 1, further comprising the step of:
adapting the physical layout diagram to a circuit schematic, wherein the circuit schematic comprises at least one of a plurality of static random access memory cells and a plurality of dynamic random access memory cells.

3. The method of claim 1, further comprising the step of:
based on the physical layout diagram of the circuit, obtaining the virtual representation of the fabricated circuit that accounts for one or more of patterning process variations and local variations that can occur during the circuit production process.

4. The method of claim 1, further comprising the step of
based on the physical layout diagram of the circuit, obtaining the virtual representation of the fabricated circuit that accounts for one or more of lithography variations and threshold voltage variations that can occur during the circuit production process.

5. The method of claim 1, wherein the obtaining step further comprises the steps of:
performing a lithography simulation that accounts for lithography variations that can occur during the circuit production process; and
producing the virtual representation of the fabricated circuit, based on the lithography simulation, that has a geometry that is different from the physical layout diagram.

6. The method of claim 5, wherein the physical layout diagram comprises a plurality of polygons, each having a length dimension and a width dimension, and wherein the obtaining step further comprises the step of:
producing the virtual representation of the fabricated circuit, based on the lithography simulation, that has one or more polygons with a length dimension and a width dimension that are equivalent to the length dimension and the width dimension of one or more of the polygons in the physical layout diagram.

7. The method of claim 1, wherein the obtaining step further comprising the step of:
performing a process-aware extraction that accounts for lithography variations that can occur during the circuit production process.

8. The method of claim 1, wherein the obtaining step further comprises the step of:
performing a resistance capacitance extraction wherein the physical layout diagram is translated into an electrically equivalent network described in the form of a netlist.

9. The method of claim 8, wherein the obtaining step further comprises the steps of:
performing a lithography simulation that accounts for lithography variations that can occur during the circuit production process;
producing the virtual representation of the fabricated circuit, based on the lithography simulation, that has a geometry that is different from the physical layout diagram; and
modifying the netlist with the virtual representation of the fabricated circuit.

10. The method of claim 9, further comprising the step of:
substituting the geometry of the virtual representation in place of a geometry of the physical layout diagram.

11. The method of claim 8, further comprising the step of:
processing the netlist using a circuit simulator which accounts for local variations that can occur during the circuit production process.

12. The method of claim 1, wherein the obtaining step further comprises the step of:
performing an optical proximity correction on the physical layout diagram.

13. The method of claim 1, wherein the physical layout diagram comprises a plurality of polygons, and wherein the obtaining step further comprises the step of:
performing an optical proximity correction which modifies one or more of the polygons in the physical layout diagram.

14. The method of claim 3, further comprising the step of determining a mean and standard deviation for the patterning process variations.

15. The method of claim 3, further comprising the step of:
determining a mean and standard deviation for the local variations.

16. The method of claim 1, further comprising the step of:
using a disturb fail metric to project a production yield for the virtual representation of the fabricated circuit.

17. An apparatus for virtual fabrication of a process-sensitive circuit, the apparatus comprising:
a memory; and
at least one processor, coupled to the memory, operative to:
based on a physical layout diagram of the circuit, obtain a virtual representation of the fabricated circuit that accounts for one or more variations that can occur during a circuit production process;
use a quality-based metric to project a production yield for the virtual representation of the fabricated circuit;
modify one or more of the physical layout diagram and the production process; and
repeat the obtain, use and modify steps until a desired projected production yield is attained.

18. The apparatus of claim 17, wherein the at least one processor is further operative to:
based on the physical layout diagram of the circuit, obtain the virtual representation of the fabricated circuit that accounts for one or more of patterning process variations and local variations that can occur during the circuit production process.

19. An article of manufacture for virtual fabrication of a process-sensitive circuit, comprising a machine-readable medium containing one or more programs which when executed implement the steps of:
based on a physical layout diagram of the circuit, obtaining a virtual representation of the fabricated circuit that accounts for one or more variations that can occur during a circuit production process;
using a quality-based metric to project a production yield for the virtual representation of the fabricated circuit;
modifying one or more of the physical layout diagram and the production process; and
repeating the obtaining, using and modifying steps until a desired projected production yield is attained.

20. The article of manufacture of claim 19, wherein the one or more programs when executed further implement the step of:
based on the physical layout diagram of the circuit, obtaining the virtual representation of the fabricated circuit that accounts for one or more of patterning process variations and local variations that can occur during the circuit production process.
